(19) United States
(12) Patent Application Publication
(10) Pub. No.: US 2014/0278971 A1
(43) Pub. Date: Sep. 18, 2014

(54) CAUSE-BASED MARKETING SYSTEM

(71) Applicant: SNAPCAUSE LLC, Lansdale, PA (US)

(72) Inventors: Robert Neubert, Hatfield, PA (US); Joshua R. Neubert, Hatfield, PA (US); Benjamin C. Neubert, Hatfield, PA (US)

(73) Assignee: SNAPCAUSE LLC, Lansdale, PA (US)

(21) Appl. No.: 13/834,109

(22) Filed: Mar. 15, 2013

(51) Int. Cl. G06Q 30/02

(52) U.S. Cl. CPC G06Q 30/0251; G06Q 30/0279
USPC 705/14.53; 705/14.4; 705/14.61

(57) ABSTRACT

A system for cause-based marketing including an interface to communicate with registered merchants, causes and users, a memory to store data associated with activities of the registered merchants, causes and users, and at least one processor coupled to said interface and said memory, said at least one processor configured to: facilitate each registered user to associate with one or more of the registered causes; facilitate each registered user to view offers of donation from registered merchants to the causes with which the user is associated; record transactional data evidencing a registered user's transaction with an offering merchant; facilitate a user to allocate a donation resulting from a transaction with an offering merchant amongst the causes with which the user is associated; compile donation amounts allocated to each registered cause; and facilitate transfer of the compiled donation amounts from the registered merchants to the registered causes.

### FIELD OF THE INVENTION

This invention relates to a marketing system. More particularly, this invention relates to a marking system which coordinates causes and their members with merchants.

### BACKGROUND OF THE INVENTION

In many instances, causes such as non-profits, charities, schools, clubs and other organizations rely on fund-raising and donations for the operation of their group. Merchants recognize the purchasing power of members of these causes and are often willing to make donations or assist with fund-raising for these causes in exchange for patronizing of the merchant by the cause members. Typically, the merchant will agree to a donation offer and the cause will attempt to market the specific offer to its members and encourage participation, however, often such messages are not well received. For one, cause members may not like repeatedly receiving unsolicited promotions. Additionally, many offers are time dependent and may not coincide with the member's schedule.

There exists a need for a system and method whereby cause members can easily identify available merchant offers in support of their causes and then utilize the offers in a manner which does not disrupt the user's routine.

### SUMMARY OF THE INVENTION

Briefly, the present invention provides a marketing system which coordinates causes and their members with merchants.

In one aspect, the invention provides a system for cause-based marketing including an interface to communicate with registered merchants, causes and users; a memory to store data associated with activities of the registered merchants, causes and users; and at least one processor coupled to said interface and said memory, said at least one processor configured to: associate the at least one registered user with at least one of the at least one registered causes; offer at least one donation from a registered merchant to a registered cause based on a registered user transaction with the offering merchant; record transactional data evidencing the registered user transaction with the offering merchant; verify from the transactional data that the registered user transaction met offer criteria established by the merchant; and facilitate donation of said offered donation from the registered merchant to the registered cause for each verified transaction.

In another aspect, the invention provides a cause-based marketing method including the steps of registering, by a computing device, at least one merchant, at least one cause and at least one user; associating, by said computing device, the at least one registered user with at least one of the at least one registered causes; offering, by said computing device, at least one donation from a registered merchant to a registered cause based on a registered user transaction with the offering merchant; recording, by said computing device, transactional data evidencing the registered user transaction with the offering merchant; verifying, by said computing device, from the transactional data that the registered user transaction met offer criteria established by the merchant; and facilitating, by said computing device, donation of said offered donation from the registered merchant to the registered cause for each verified transaction.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a schematic diagram of a cause-based marketing system in accordance with an embodiment of the present invention.

FIG. 2 is a table illustrating exemplary offering relationship between merchants and causes.

FIG. 3 is a table illustrating exemplary association between users and causes.

FIG. 4 provides tables for each exemplary user illustrating the merchant/cause offerings available to the user.

FIG. 5 is a schematic diagram of a cause-based marketing system in accordance with an embodiment of the present invention.

FIG. 6 is a flow chart illustrating an exemplary user recruiting process in accordance with an embodiment of the invention.

FIG. 7 is a schematic diagram of an exemplary merchant portal.

FIG. 8 is an illustration of an exemplary merchant cause approval page.

FIG. 9 is an illustration of an exemplary merchant offer creation page and FIGS. 10 and 11 illustrate sub-pages for entering specific offer criteria.

FIG. 12 is a schematic diagram of an exemplary user portal.

FIGS. 13 and 15-19 are illustrations of various pages within the exemplary user portal

FIG. 14 is an illustration of an exemplary practical geo-location map.

FIG. 20 is a flow chart of an exemplary payment process.

FIG. 21 is a flow chart of another exemplary payment process.

### DETAILED DESCRIPTION OF THE INVENTION

In the drawings, like numerals indicate like elements throughout. Certain terminology is used herein for convenience only and is not to be taken as a limitation on the present invention. The following describes preferred embodiments of the present invention. However, it should be understood, based on this disclosure, that the invention is not limited by the preferred embodiment described herein.

Referring to FIGS. 1 and 2, a cause-based marketing system 10 in accordance with an embodiment if the invention will be described. The system 10 is a computing device 110 (see FIG. 5) configured to register merchants 20 and causes 30 as indicated by arrows 22 and 32. Merchant is intended to have a broad meaning and generally includes any individual or entity providing a good or service, for example, but not limited to, restaurants, hotels, stores, service providers and other businesses, whether in person, on-line, via a mobile application or otherwise. Similarly, cause is intended to have a broad meaning and generally includes entities and other organizations involved in receiving donations or in fund-raising activities, for example, non-profit or other charitable institutions, schools and sports teams and clubs.

In a preferred embodiment, the system 10 implements an approval process to ensure that a cause 30 meets minimum registration requirements before registration of the cause 30. For example, the system 10 may be configured to check one or more of the following: 501(c) 3 verification, physical site verification, on-line presence verification, association with an approved cause (e.g. a soccer team associated with an approved soccer club), and third-party verified lists or databases.

Each of the registered merchants 20 then approves, as indicated at arrow 24, causes 30 from the registered causes to which the merchant 20 is willing to make donations or other contributions, for example, financial support, wish list items, merchandise, services, marketing or co-marketing fees, etc. As described below, the merchants 20 preferably can utilize the system 10 to specify specific offers to specific causes 20. Additionally, in one or more embodiments as described below, causes 30 can utilize the system 10 to recruit merchants 20 to register with the system 10 and to support the cause. The table in FIG. 2 illustrates an exemplary group of registered merchants M1-M3 and the causes C1-C12 which each merchant 20 has approved along with an associated offer rate 23. The offer rates 23 typically represent a percentage of the qualifying sales the merchant 20 is willing to donate to the cause 30. In the exemplary illustration, merchant M1 has approved four causes C1-C4, each with an offer rate 23 of 10%; merchant M2 has approved two causes C1 and C12, both with an offer rate 23 of 15%; and merchant M3 has approved three causes C1, C6 and C10, with the offer rates 23 varying at 10%, 20% and 15% respectively.

The system 10 is also configured to register users 40. Users are members of or otherwise supporters of one of the registered causes 30. Upon registration, each user 40 associates themselves with at least one cause 30. The table in FIG. 3 illustrates an exemplary group of registered users U1-U7 and the causes C1-C12 that each user 40 is associated with. Various methods can be utilized for recruiting users 40 to register with the system 10 and associate with one or more causes 30, as will be described in more detail below. With causes 30 approved by merchants 20 and users 40 associated with causes 30, the system 10 is configured to coordinate opportunities for users 40 to facilitate donations to their causes 30 by patronizing the appropriate merchants 20. The tables in FIG. 4 illustrate each merchant/cause opportunity each of the exemplary users U1-U7 have available to them based on the approvals and associations of FIGS. 2 and 3. For example, user U1 can support all four of its causes C1-C4 by patronizing merchant M1, further support cause C1 by patronizing merchant M2 and further support cause C2 by patronizing merchant M3.

Once registered, a user 40 may access the system 10, as indicated at 42, through a communication device 140 (see FIG. 5) to determine which merchants 20 have approved offers to the user's associated causes 30. After the user 40 has patronized one of the approving merchants 20 and the qualifying sale has been registered with the system 10, the merchant 20 will make a donation to the selected cause 30, as indicated by arrow 26. While FIG. 1 illustrates the donation directly from the merchant 20 to the cause 30, in a preferred embodiment as described hereinafter, the system administration collects the payment from the merchant 20 and makes payment to the cause 30.

Having described the general operation of an embodiment of the system 10, the system 10 will be described in more detail with reference to FIG. 5. The system 10 may comprise a computing device 110 which typically includes a processor 111 and memory 112. The memory 112 may be utilized to store, for example, instructions that cause the processor 111 to perform various tasks and steps of the system 10. The memory 112 may also be utilized to store, for example, registration information for the merchants 20, causes 30 and users 40 as well as information relating to the offers and payments. The system 10 is also illustrated with a mapping data base 113 which may be utilized to coordinate a user's geo-graphic location with merchant locations, as described in more detail below. The mapping data base 113 may be stored in the memory 112 or may be stored in an external memory, as illustrated. Alternatively, the mapping data base 113 may be stored on another server, for example, the server of a third party mapping provider, which is in communication with the computing device 110.

The computing device 110 may take the form of a server or any computing device having a processor. Thus, the computing device 110 may also take the form of a laptop, digital assistant, tablet computer, personal computer, or other computing device able to execute computer readable instructions.

The processor 111 may be referred to as a main processor or central processing unit (CPU). The processor 111 may include a single or multiple processing cores. Where two or more cores are provided, the cores may be capable of operating in parallel.

The memory 112 may comprise any number and combination of memory devices including but not limited to cache memory, such as static random access memory (SRAM), dynamic random access memory (DRAM), enhanced DRAM or the like. Any storage repository or non-transitory machine readable storage medium of a type known in the art may also be used. The processor 111 accesses the memory 112 through a communications bus or the like (not shown) to access any application or data stored thereon including, but not limited to, any computer readable instructions.

The system 10 further includes a plurality of portals which facilitate access and operation within the system 10. For example, an administration portal 114 is associated with the computing device 110. The administration portal 114 includes input and output devices which allow a system administrator to perform administrative tasks within the system 10. For example, the administrative tasks may include activating/deactivating a merchant, cause or user or preparing reports of activity within the system 10. Payment processing and customer relationship management (CRM) portals 117 and 119, the function of each will be described below, are also associated with the computing device 110. The payment processing and CRM platform 117 and 119 may be separate interfaces or may be part of the administration portal 114.

Merchant portals 120 and cause portals 130 as well as user communication devices 140 are also associated with the computing device 110. On a basic level, the portals 120, 130 and the communication devices 140 allow the different entities to register with the system 10, control offers and associations, and see reports on their respective activities. As part of the activity reports, the system 10 may tracks transaction allocations to causes and provide reports to users and/or merchants as a receipt for charitable tax deductions. Additional functionality of each of these portals 120, 130 and the devices 140 is described below.

These portals 120 and 130 and the devices 140 may utilize separate interfaces, may be accessed through a system website 115 associated with the computing device 110, or a combination thereof. The system website 115 may include system information, e.g. “About Us”, “Product Information”, “Application Download”, “Testimonials” and “Blogs”, but may also include sign in and registration access for merchants, causes and users. Alternatively or additionally, such sign in and registration access may be provided by a direct access application, for example on a smart phone, which allows the entity to access the system 10 without going through the website 115.

Each user communication device 140 is preferably in the form of a mobile device, for example, a smart phone, tablet, or other mobile computing device having a geo-location capability, however, alternatively or additionally, the user communication device 140 may be a stationary device, for example, in the form of a desktop computer or the like. The geo-locator component may include a location application of a type known in the art. For example, if the user accesses the system 10 from a desktop computer or the like, the computer's IP address may provide geo-location information. Alternatively, in a mobile device the geo-locator may include a global positioning system (GPS) receiver or like. Regardless of its configuration, the geo-locator is capable of accurately identifying the geographic position of the user communication device 140. It is also preferred that the communication device 140 include an image processing device 162 which allows the user 140 to record receipts as described below.

The various components of the system 10 may interface with the computing device 110 via wired or wireless communication over one or more networks. The networks may comprise any network of a type known in the art including but not limited to a local area network (LAN), a wide area network (WAN), a wireless network or any other network or network of networks including that generally known as the internet.

The following description provides exemplary functionality of the various portals. A system 10 in accordance with the invention may include none, all or any combination of the described functions.

Referring to FIG. 6, an exemplary user recruitment function will be described. With this function, either merchants 20 or causes 30 may recruit users 40 to use the system 10. The recruitment function begins with a merchant 20 or cause 30 uploading contacts 200 to the system 10. The contacts can come from various sources, for example, a merchant's mailing list or a cause's member list. Such uploading is done through the respective merchant portal 120 or cause portal 130 and can take various forms, for example, manual entry 201, uploading of an excel, CSV or other file 202, or uploading email contacts 203, 204. The merchant 20 or cause 30 then creates a custom message 205 advising the newly uploaded contacts of the entity's involvement with the fund-raising activities of the system 10 and inviting each contact to register with the system 10 if interested. The message is sent to each of the newly uploaded contacts 206 by the entity through the system 10.

The function then takes different paths depending on whether the message was sent from a merchant 20 or a cause 30. If the message was sent from a cause 30, the system 10 checks at 207 to see if the contact's email is already registered with the system 10. If the contact is already a registered user 40, then it is unnecessary to send the invite message and instead the system 10 sends a message to the user's communication device 140 at 208 to notify the user 40 that the cause 30 is registered with the system 10 and requesting that the user 40 associate with the cause 30. The contact is given the option at 209 to accept association with the cause 30. If the user 40 accepts at 210, the cause 30 is now recognized as an associated cause in the user's communication device 140. If the user 40 declines at 211, the process ends without an association. In either event, the system records are updated so that the cause 30 may check the user's decision. Returning to 207, if the email of the contact receiving the message is not registered in the system 10, then the cause's custom message is sent at 212 to the contact with information on the cause and on the system 10 and requesting the contact to register and support the cause 30. The contact is given the option at 213 to accept association with the cause 30. If the contact accepts at 214, the contact may download a system application to the user's communication device and register with the system 10. Upon registration, the cause 30 will be recognized as an associated cause in the user's communication device 140. If the contact declines at 215, the process ends without the contact registering. In either event, the system records are updated so that the cause 30 may check the contact's decision.

In recruiting user's or encouraging user use of the system 10, and thereby increase donations to the cause, causes 30 may provide incentives to the users 40. For example, a cause that is a sports league may provide an incentive wherein all donations as a result of user 40 transactions offset the user's league fees. In this regard and for other reasons, usage of cause members may be associated with a family account. For example, members of a family may register all or some of their family members under the cause member account so that transactions can be compiled to offset activity fees associated to individual family members.

If the message was sent from a merchant 20, the system 10 checks at 216 to see if the contact's email is already registered with the system 10. If the contact is already a registered user 40, then it is unnecessary to send the invite message and instead the system 10 sends a message to the user's communication device 140 at 217 to notify the user 40 that the merchant 20 is registered with the system 10. If the email of the contact is not registered with the system 10, the merchant's message is sent at 218 to the contact with information about the system 10 and requesting that the contact register with the system 10 to support the cause 30. The contact is given the option at 219 to accept the invitation to register with the system 10. If the contact accepts at 220, the contact may download a system application to the user's communication device and register with the system 10. If the contact declines at 221, the process ends without the contact registering. In either event, the system records are updated so that the merchant 20 may check the contact's decision.

Referring to FIGS. 7-11, additional preferred functionality of the merchant portal 120 will be described. In the embodiment illustrated in FIG. 7, the merchant portal 120 accesses the system 10 through a web application on they system website 115, however, additional or alternative access means may be utilized. Within the merchant portal 120, a merchant administrator may attend to administrative functions regarding the merchant's use of the system 10. As illustrated, there is functionality to allow the merchant administrator to control the merchant's settings, to review billing information and review activity reports.

The merchant portal 120 also allows the merchant administrator to manage causes 30 approved by the merchant 20. Referring to FIG. 8, an exemplary cause approval page 230 will be described. In the illustrated embodiment, the cause approval page 230 includes a section 232 listing the currently approved causes 30. Basic information about each cause 30 is included and the administrator has the option to remove any of the approved causes 30.

A cause category section 234 is also provided which allows the administrator to select an entire category 236 of causes 30 or a sub-category 236a, 236b for approval. In the illustrated example, the category 236 is local schools, e.g. schools within a certain geo-graphic area, and the sub-categories are private schools 236a within that area or public schools 236b within that area. The administrator may select any number of categories to provide offers to all registered causes 30 falling within the selected category/sub-category.

If the administrator would like to select specific causes 30, a cause search area 237 is provided. The cause search area 237 includes a results list 238 which may be populated by default with recommended causes 30. The recommended causes 230 may be selected based on various criteria, for example, cause demographics, cause member neighborhood location distribution, cause mission categorization, cause tax filing status, historical cause member shopping locations, cause member purchasing data, and financial transaction method data. For example, the system 10 may identify the most productive causes, i.e. causes who members are users 40 and frequently respond to offers. A search bar 239 is also provided which allows the administrator to search for specific causes 30 based on various criteria, e.g. name, location, category, etc.

Additionally, causes may utilize the system 10 to invite a merchant 20 to add their cause 30 to the merchant approval list. Causes 30 may base such merchant invitations on cause member requests or the system 10 may provide the causes 30 with recommendations of which merchants 20 would make good donations. For example, the system 10 may make recommendations based on merchants that have marketing geo-territories that match the home and/or work locations of users 40 supporting the cause 30. The cause 30 can utilize the system invitation to taut the large number of cause members living near the merchant, may stop in the merchant or the large number of cause members may make recommendations as they frequent the merchant.

Referring to FIGS. 9-11, an exemplary offer creation page 240 will be described. The offer creation page 240 has a selection area 242 which allows the administrator to select which causes 30 the created offers will apply to, for example, all causes, causes within a select category, or an individual cause. The page 240 also includes a default offer area 244 whereat the administrator may set a default offer which applies at all times a special offer is not available. In the illustrated embodiment, the default offer is easily controlled by a slider bar 245. In addition to the default offer, the page 240 includes a section 246 to create custom offers. In the illustrated embodiment, the custom offer section 246 has an area corresponding to each day of the week, allowing the administrator to create a special or custom offer for a given time period on a given day. As illustrated, different offers may be provided at different times of the day, for example, to provide incentives during slow times of the day, e.g. lunch, or tied to specific events, e.g. a football game on a Monday night. In addition to or alternatively, the page 240 may include a calendar section which allows custom offers for specific dates to be created. FIGS. 10 and 11 illustrate exemplary sub-pages 241a and 241b which may be utilized to define a special offer. The first sub-page 241a allows the administrator to define the time period of the offer, in the illustrated embodiment, using a dual-button slider bar 247. Once the time is set, the system 10 moves to the next sub-page 241b whereat the administrator sets the offer for the selected period, in the illustrated embodiment using a slider bar 249. The system 10 may create default or suggested offer templates for merchants based on various factors, e.g. type of merchant, the merchant's time, date, historical sales activity levels, labor considerations, market considerations, and other offers in the system.

Referring to FIGS. 12-19, exemplary functionality of the user communication device 140 will be described. In the illustrations, the user communication device 140 is a smart phone, however, other mobile or stationary computing processing devices may be utilized. In the illustrated embodiment, the user 40 has downloaded the system application 142 onto their communication device 140 which allows them to easily access the user portal of the system 10. Upon opening the application 142, the user 40 is brought to a home page 141 where they can select between a donation or merchant selection page 151, a recording page 161 and a settings page 181. The settings page 181 allows the user 40 to manage various settings. The illustrated settings are generally self-explanatory and can be configured to any level of complexity. In a preferred embodiment, the manage locations sub-page 183 allows the user 40 to define multiple “favorite” locations, e.g. home, work, school, which allows the system 10 to easily search in the designated location even if the user 40 is not currently at that location.

When the user 40 would like to find merchants that have made offers for the user's associated causes, the user 40 navigates to the merchant/donation screen 141 as shown in FIG. 13. The screen 141 displays a number of merchant offers 143a-143d corresponding to offers to at least one of the user's associated causes 30. While four offers 143 are shown, more offers may be available based on configuration of the screen and also by scrolling the screen. The offers 143 which are displayed are based on various criteria, including for example, location of user and merchants, ratings of merchants, value of offer, cause/merchant matches, merchant special offers, historical usage of a merchant offer, member upgrade potential, member loyalty levels, time of the transaction. If the user 40 does not see an offer 143 that interests them or if they are interested in patronizing a specific merchant 30, the user 40 can utilize the search bar 146 to search for additional merchants 30, for example, by name, different location, category, etc.

The location criteria used by the system 10 is preferably a practical geo-location criteria as described with respect to FIG. 14. In FIG. 14, a first user 40a is located in a rural area 250 with several merchants 30a-30e spread over a wide area and a second user 40b is located in a more densely populated area 260, e.g. a city, with many merchants 30f-30m, etc. within a much smaller geo-graphic area. The system 10 utilizes the mapping data base 113 and is preferably configured to determine the type of area the user 40 is in and then define the target merchant area 251, 252 based on the characteristics of the area. In the illustrated embodiment, the system 10 is configured to presume that user 40a is willing to travel to merchants 30 utilizing a car or other means of transportation while user 40b would prefer not to have to use a car, but instead would prefer to walk or have only a short cab ride. As such, the system 10 utilizes a merchant target area 251 for user 40a that is larger than the merchant target area 261 for user 40b. The user 40 may override the presumptions, for example, if user 40b is willing to take the subway or happens to be visiting the city in a car and therefore can travel further.

Additionally, the system 10 is preferably configured to account for “barriers” that override a simple radius approach to defining the target area. In the illustrated embodiment, user 40a is located closer to merchant 30f than to any of merchants 30a-30e, however, a river 252 separates the user 40a from the merchant 30f and the bridge 254 does not provide easy access to cross the river 252. Accordingly, the system 10 is configured to limit the range of the merchant target area 251 to the user's side of the river 252. The system 10 can be configured to identify various “barriers” which are considered in defining the target area, for example, toll roads, highways driving, predicted congested driving. Again, the user 40 can select to override one or more of these considerations.

Referring again to FIGS. 13 and 15, the user 40 can select one of the suggested offers or a searched for offer and the user 40 is taken to a merchant offer screen 151. From the offer screen 151, the user 40 is provided with additional information regarding the merchant 20 and the offers being offered by the merchant 20. The merchant 20 information may include, for example, address, phone, website, and rating information, any of which may be hyperlinked to allow the user to utilize, e.g. the phone number, or access more detailed information, e.g. website or ratings, by clicking on the link. Clicking on the directions button 153 will open a default mapping program which will provide directions from the user's current location to the merchant location. The offer page 151 preferably includes the current offer 154 and upcoming offers 156. The user 40 can save any of the offers 154, 156 to their calendar by clicking on the calendar button 155.

Once a user 40 selects an offer, they simply patronize the merchant 20 during the designated period and then register the transaction with the system 10. Various methods may be utilized to register the transaction. In one embodiment illustrated in FIGS. 12 and 16-19, the user 40 registers the transaction by uploading a picture of the transaction receipt 164 to the system 10. In the application 142, the user 40 clicks the camera icon 162 which takes them to the camera recording screen 161, which initially is a picture capture screen 161a. The user 40 aligns the receipt 164 within the capture screen 161a then captures an image of the receipt 164 as shown in FIG. 16. The system 10 may include functionality which allows the user 40 to confirm clarity of the image and/or to capture multiple images for larger receipts. Once the user 40 has captured an appropriate image, the system moves to a merchant selection screen 161b as shown in FIG. 17. The system 10 is preferably configured to list geographically close merchants, but also includes a search bar to allow searching for a specific merchant or within a specific location.

Once the merchant 20 corresponding to the receipt 164 has been selected, the system 10 proceeds to a cause selection screen 161c as shown in FIG. 18. The cause selection screen 161c lists each of the user's associated causes 30. Causes 30′ not supported by the merchant 20 may be grayed out, not shown, or otherwise not available for selection. The user 40 then selects the causes 30 to which the user wants the merchant's donation to go to. The user 40 may select a single cause or multiple causes 30 for a single transaction. If multiple causes 30 are selected, the donation from the transaction will be split among the causes 30. Preferably, for simplicity, the split will be even amongst the causes, however, it is contemplated that the user 40 could select the distribution amongst the causes 30. Once the causes 30 are selected, registration of the transaction is complete and the user 40 receives a confirmation page as shown in FIG. 19. The user 40 may be given the opportunity to rate the merchant, share their experience via social media, upload photos of their experience to the system and record other receipts. Merchants 20 may provide additional donations in response to photographs, video, recordings, reviews, ratings and other feedback from users 40.

In an alternative embodiment, users 40 do not register their own transactions, but instead submit copies of their receipts to a selected cause 30. The cause 30 would then submit batches of receipts 164 to the system 10 wherein the receipts would be registered and verified.

In yet another alternative embodiment, the merchant 20 may have hardware and software at the merchant point of sale (POS) which is able to communicate with the user's communication device 140. For example, near field communication or other form of communication may be utilized. The merchant POS hardware will be configured to capture transactional data of user's transactions and then submit the transactional data to the system 10. The transactional data would then be used by the system 10 for transaction verification.

While a few transaction data capture methods have been described, it is recognized that other methods may be utilized and that multiple methods may be utilized at one time.

Regardless of the method of capture, the system 10 verifies the data in the payment processing portal 117 before making any payments. An illustrative payment process 270 is shown in FIG. 20. At step 271, the system 10 receives the captured transactional data. At step 272, the system 10 verifies the transactions to confirm that each transaction met the merchant's criteria, e.g. the transaction occurred during the offer period and the user 40 was an active member at the time of the transaction. For each verified transaction, the system 10 at 273 then calculates the donation amount for the transaction, i.e. multiplying the offer rate times the transaction amount and then determining if it is split amongst multiple causes 30. The calculated donation amount is then posted to the appropriate merchant account as a negative and to the appropriate cause account(s) as a positive as shown at 274. Periodically, for example once per month, the system 10 pays all donations in each cause's account to the cause 30, at 275, and invoices all donations in each merchant's account to the merchant 20, at 276.

Referring to FIG. 21, an alternative payment process 280 is illustrated and may be used in conjunction with or instead of payment process 270. In the payment process 280, a user 40 pre-registers a payment account, e.g. a debit card, with the system 10, as indicated at 281. In step 282, the user 40 conducts a transaction at a merchant 20 in accordance with a merchant order, however, the user 40 does not pay the merchant directly for the transaction. Transaction data is transmitted to and received by the system 10 as indicated at 283. Preferably, such transmission is performed by the merchant 20 and is not dependent on submission by the user 40. Upon receipt of the transaction data, the system 10 is configured at step 284 to debit the user's account for the amount of the transaction, regardless of whether the transaction actually met the merchant's offer criteria. At step 285, the system 10 verifies the transaction to confirm that the transaction met the merchant's criteria, e.g. the transaction occurred during the offer period and the user 40 was an active member at the time of the transaction. For each verified transaction, the system 10 at 286 then calculates the donation amount for the transaction, i.e. multiplying the offer rate times the transaction amount and then determining if it is split amongst multiple causes 30. At 287, the system 10 credits the merchant's account for the amount of the transaction less the verified donation amount and a handling fee. The calculated donation amount is also posted to the appropriate cause account(s) as a positive as shown at 288. Periodically, for example once per month, the system 10 pays all donations in each cause's account to the cause 30, at 289, and pays the balance of each merchant's account to the merchant 20, at 290.

The CRM platform 119 may be configured in various ways to enhance the marketing of merchants 20 and causes 30 and also may facilitate cross-marketing. The system 10 may be configured to implement one or more of the following functions to enhance merchant marketing. In one embodiment, the CRM platform 119 is configured to perform an ongoing analysis of a merchant's POS system data to optimize marketing and operations based upon merchant type, merchant revenue, time, date, historical sales activity levels, labor considerations, market considerations, staffing, current sales activity level, scheduled marketing events. The system 10 may provide alerts to key merchant stakeholders based upon customer preferences, offer favorability and the like to maximize the merchant benefit from the system 10.

In another aspect, the CRM platform 119 may be configured to predict user 40 activity based on merchant offer characteristics, offer timings, cause communications, calendar additions, characteristics of the merchant 20, characteristics of the user 40, characteristics of the cause 30, historical performance of system activity, and commitment effect of the user 40. By tracking historical user utilization, both causewide and per individual user, allows the system 10 to better predict offer utilization as well as help target offers

The CRM platform 119 may also facilitate a dynamic bid platform that optimizes the offers merchants 20 market to an individual cause 30 or groups of causes 30. The dynamic bid platform considers market conditions such as the number and amount of deals in the market and factors such as time, date, and location. The system 10 may set max bids, report potential opportunities to merchants, and offer recommendations to merchants based upon market conditions.

The CRM platform 119 may also allow the merchant 20 to enhance utilization by providing incentives to causes 30 or users 40. For example, the merchant 20 indicates that it will increase the offer rate from 10% to 15% when cause specific users exceed $500 of transactions in a given time period. The system 10 may be used to communicate to the cause's users the need for additional activity to reach a milestone. Similarly, the merchant can agree to increase the offer rate from 10% to 15% when a specific user 40 exceeds $500 of transactions in a given time period. Again, the system 10 may be used to communicate to the user the need for additional activity to reach a milestone.

In another aspect, the CRM platform 119 may be used by the merchant 20 to create a “tournament” to increase user participation. The tournament design allows for a merchant to promote cause member usage among multiple causes by awarding an enhanced donation commitment to the top revenue generating causes. For example, the merchant sponsors a tournament where ten soccer team causes compete with each other for revenue generation at their local affiliated merchant. Sales are tracked for the period of the tournament and the enhances the top three teams with an additional donation.

In another aspect, the CRM platform 119 can be configured to calculate the cause mindedness of a particular merchant 20. An algorithm may be applied to consider such factors as the number of causes supported, the level of donations to causes, the number of volunteer hours by merchant employees to causes, timeliness of donation payments, co-promotion frequency, event marketing frequency, event marketing frequency, frequency of wish list donations and user feedback. The cause mindedness ranking of each merchant 20 may be used within the system 10 as a factor in determining search list result order. The rankings may also be made available to users 40.

The CRM platform 119, or other aspects of the system 10, may be utilized by causes 30 to enhance their marketing. As one example, the system 10 can be used to recommend causes 30 to a user 40 based upon geo-location, demographic information, access device information, similarity to other causes on the user's cause list, and characteristics of the population within their proximity.

Causes 30 can also utilize the system 10 to inform users 40 of specific events at one or merchants 20 that benefit the cause. The platform may be configured to remind users 40 of the cause fundraising events and allows users to add the events to their calendar. The cause 30 can track user 40 sign-up, i.e. adding it the event to their calendar, and predict the level of participation. If participation appears low, more marketing of the event can take place.

In this regard, the platform preferably allows the cause 30 to create automated messaging between the cause administrator and the cause constituency based upon offers in the current system, group events, and external factors including time, date, and location. To further enhance this feature, the system 10 may provide for an mail signature tool that appends communications from cause administrators to cause members with functionality that communicates fundraising programs, fundraising events, wishlist items, etc. Fundraising messages, updates and offers are channeled based upon the cause/user pairings. For example, and email from a soccer coach has a signature tool that auto updates information about the team or clubs fundraising efforts.

As mentioned above, the cause 30 may want to communicate a wishlist of desired items. By providing a list of tangible items, it may provide motivation for donations from cause members or to motivate transaction with merchants that commit to making donations to causes. The system 10 may also be configured to facilitate direct user donation for items on the list or simply general donations.

The CRM platform 119 may also facilitate co-marketing between merchants 20 and causes 30. For example, cause marketing can be refined to co-promotions to cause members located in merchant targeted neighborhoods. For example, co-promotion is only promoted to members living or working in the merchant's targeted neighborhoods rather than all of a surrounding region. Similarly, causes can promote their cause to merchant customers not currently registered in the system 10 or to merchant customers who are registered in the system 10 but have not selected their cause to support.

The CRM platform 119 may also facilitate marketing by causes 30 directed to neighborhoods or target areas that coincide with merchant targeted neighborhoods or areas. For example, a cause can send a direct mail, email or message campaign to only those associated users 40 that live or work in an area targeted by merchant deals within that area. This saves the cause 30 time and expense of sending the message to users who are less likely to respond to the deal and avoids the users receiving messages about deals that are not local to them.

In another aspect, the platform can be configured to send merchant special product offerings to members of specific causes with the endorsement of the cause. For example, a restaurant promotes its gluten free menu for celiacs and it promotes donation commitment using the system 10 to members of Celiac Disease Foundation with the endorsement of the foundation.

Various functionality of the system 10 is described herein. A system 10 in accordance with the present invention may use only portions of the functionality while still performing within the scope of the invention.

The advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as defined in the claims.

What is claimed is:

1. A system for cause-based marketing, comprising:
an interface to communicate with registered merchants, causes and users;
a memory to store data associated with activities of the registered merchants, causes and users; and
at least one processor coupled to said interface and said memory, said at least one processor configured to:
facilitate each registered user to associate with one or more of the registered causes;
facilitate each registered user to view offers of donation from registered merchants to the causes with which the user is associated;
record transactional data evidencing a registered user's transaction with an offering merchant;
facilitate a user to allocate a donation resulting from a transaction with an offering merchant amongst the causes with which the user is associated;
compile donation amounts allocated to each registered cause; and
facilitate transfer of the compiled donation amounts from the registered merchants to the registered causes.

2. The system according to claim 1 wherein the processor is further configured to facilitate collection of the compiled donation amounts from each registered merchant and to facilitate distribution of the compiled donation amounts to the registered causes.

3. The system according to claim 1 wherein the processor is further configured to present a sub-list of a user's associated causes that have received the merchant offer of donation to assist the user in allocating a donation.

4. The system according to claim 1 wherein transactional data is recorded through capture an image of the purchasing transaction receipt and submittal of the image through the processor.

5. The system according to claim 1 wherein merchants may assign offer criteria to donation offers to causes.

6. The system according to claim 5 wherein the offer criteria includes a specific day and/or time during which the user transaction must take place.

7. The system according to claim 5 wherein the processor is configured to provide a merchant with a template of offer criteria based on historical transaction data matched to characteristics of the merchant.

8. The system according to claim 5 wherein the processor is configured to provide a merchant with a template of offer criteria based on one or more of the following factors: merchant type, merchant revenue, time, date, historical sales activity levels, labor considerations, market considerations, and other donation offers in the system memory.

9. The system according to claim 1 wherein a merchant may provide different offers to different causes.

10. The system according to claim 9 wherein the merchant offers may be based on characteristics of the cause and/or characteristics of users associated with the cause.

11. The system according to claim 1 wherein the processor is further configured to make cause suggestions to merchants based on a cause registration certification algorithm.

12. The system according to claim 11 wherein the cause registration certification algorithm utilizes one or more of the following factors: cause demographics, cause member neighborhood location distribution, cause mission categorization, cause tax filing status, historical cause member shopping locations, cause member purchasing data, and financial transaction method data.

13. The system according to claim 1 wherein the processor is further configured to select and present offers of donation to a user based, at least in part, on the current location of the user or a user specified location relative to locations of offering merchants.

14. The system according to claim 13 wherein the processor is further configured to select and present offers of donation to a user based further on one or more of the following factors: time restrictions on an offer, the value of an offer, merchant special offers, historical usage of offers from a particular merchant, upgrade potential for the user, and user loyalty levels.

15. The system according to claim 1 wherein the processor is further configured to provide a cause administrator with a tool that appends a cause specific signature to communications from the cause administrator to users associated with the cause.

16. The system according to claim 15 wherein the signature may include information on one or more of the following items: fundraising programs, fundraising events, and wish list items.

17. The system according to claim 1 wherein the processor is further configured to facilitate uploading of a contact list of individuals by a registered merchant or a registered cause and to compare the individuals on the contact list to the list of registered users to determine whether each individual is a registered user.

18. The system according to claim 17 wherein the processor is further configured to send a message to any individual on the contact list that is not a registered user asking them if they would like to register.

19. The system according to claim 17 wherein the processor is further configured to send a message to each individual on a contact list, uploaded by a registered cause, who is a registered user but not associated with the cause requesting the user to associate to the cause.

20. The system according to claim 17 wherein the processor is configured to facilitate uploading of a contact list through manual entry, list uploading, or syncing with an existing contact list.

21. The system according to claim 1 wherein the processor is further configured to send reminders to users of upcoming fundraising events of causes with which the user is associated.

22. The system according to claim 1 wherein the processor is configured to facilitate a user adding an upcoming event to the user's electronic calendar. and allows users to add the events to their calendar.

23. The system according to claim 22 wherein the processor is configured to monitor when users add events to calendars and to report to merchants and/or causes on anticipated attendance at events based thereon.

24. A non-transitory machine readable storage medium comprising instructions that, when executed by one or more processors of a machine, cause the machine to perform operations, comprising:
register at least one merchant, at least one cause and at least one user;
facilitate each registered user to associate with one or more of the registered causes;
facilitate each registered user to view offers of donation from registered merchants to the causes with which the user is associated;
record transactional data evidencing a registered user's transaction with an offering merchant;
facilitate a user to allocate a donation resulting from a transaction with an offering merchant amongst the causes with which the user is associated;
compile donation amounts allocated to each registered cause; and
facilitate transfer of the compiled donation amounts from the registered merchants to the registered causes.

25. A cause-based marketing method, comprising:
registering, by a computing device, at least one merchant, at least one cause and at least one user;
facilitating, by said computing device, each registered user to associate with one or more of the registered causes;
facilitating, by said computing device, each registered user to view offers of donation from registered merchants to the causes with which the user is associated;
recording, by said computing device, transactional data evidencing a registered user's transaction with an offering merchant;
facilitating, by said computing device, a user to allocate a donation resulting from a transaction with an offering merchant amongst the causes with which the user is associated;
compiling, by said computing device, donation amounts allocated to each registered cause; and
facilitating, by said computing device, transfer of the compiled donation amounts from the registered merchants to the registered causes
